(19) United States
(12) Patent Application Publication
(10) Pub. No.: US 2021/0239024 A1
(43) Pub. Date: Aug. 5, 2021

(54) EXHAUST-GAS SYSTEM

(71) Applicant: Vitesco Technologies GMBH, Hannover (DE)

(72) Inventors: Sven Schepers, Troisdorf (DE); Peter Hirth, Rösrath (DE)

(73) Assignee: Vitesco Technologies GMBH, Hannover (DE)

(21) Appl. No.: 17/181,410

(22) Filed: Feb. 22, 2021

Related U.S. Application Data
(63) Continuation of application No. PCT/EP2019/072924, filed on Aug. 28, 2019.

(30) Foreign Application Priority Data
Sep. 3, 2018 (DE) 10 2018 214 922

(51) Int. Cl. F01N 3/20; F01N 3/28; F01N 13/00

(52) U.S. Cl. CPC F01N 3/2093; F01N 3/2013; F01N 13/0097; F01N 3/2053; F01N 3/2892

(57) ABSTRACT

An exhaust-gas system for guiding and aftertreating exhaust gases from an exhaust-gas source, such as an internal combustion engine, with a flow section through which the exhaust gas may flow, with at least one component which is provided for the exhaust-gas aftertreatment, is arranged in the flow section and through which the exhaust gas may flow, and with an actuator for influencing the exhaust-gas flow in the flow section. The actuator is in fluid communication with the gas volume in the flow section, as a result of which the flow direction of the exhaust gas which flows through the flow section is influenced.

### CROSS-REFERENCE TO RELATED APPLICATIONS

This application claims priority to PCT Application PCT/EP2019/072924, filed Aug. 28, 2019, which claims priority to German Patent Application No. DE 10 2018 214 922.4, filed Sep. 3, 2018. The disclosures of the above applications are incorporated herein by reference.

### FIELD OF THE INVENTION

The invention relates to an exhaust-gas system for guiding and aftertreating exhaust gases from an exhaust-gas source, such as an internal combustion engine, with a flow section through which the exhaust gas may flow, with at least one component which is provided for the exhaust-gas aftertreatment, is arranged in the flow section and through which exhaust gas may flow, and with an actuator for influencing the exhaust-gas flow in the flow section.

### BACKGROUND OF THE INVENTION

Exhaust-gas systems for the aftertreatment of exhaust gases from an internal combustion engine generally consist of flow-conducting components, such as, for example, piping and housings, and functional components, such as, for example, catalytic converters or filters. The flow passes here linearly through the exhaust-gas system from the source of the exhaust gases, i.e. the internal combustion engine, to the end of the exhaust-gas system.

Depending on the design of the exhaust-gas system, devices are also known, for example, which have a secondary branch in addition to the main exhaust-gas flow, for example to enable exhaust-gas recirculation into the combustion chamber of the internal combustion engine.

It is also known that heating devices are used in the exhaust-gas system to increase the temperature of the exhaust gas and thus more rapidly to reach the minimum temperature for exhaust-gas conversion at the catalytic converters.

A disadvantage of the devices in the prior art is that the flow passes linearly through large parts of the exhaust-gas system, and in heating devices, only once in one direction, and thus the period of time in which the exhaust gas flowing past may absorb heat from the heating device, for example, is very short. The dwell time of the exhaust gas in the region of the heating device is substantially determined by the flow velocity of the exhaust gas.

This results in the maximum amount of heat that is transferred being very low for a given heat output. It is not possible to increase the heat output at will because the available energy is limited.

### SUMMARY OF THE INVENTION

It is therefore the object of the present invention to create an exhaust-gas system which guides the exhaust gas effectively such that the amount of heat that is transferred to the exhaust gas by a heating device is maximized.

The object with regard to the exhaust-gas system is achieved by an exhaust-gas system described herein.

One exemplary embodiment of the invention relates to an exhaust-gas system for guiding and aftertreating exhaust gases from an exhaust-gas source, such as an internal combustion engine, with a flow section through which the exhaust gas may flow, with at least one component which is provided for the exhaust-gas aftertreatment, is arranged in the flow section and through which the exhaust gas may flow, and with an actuator for influencing the exhaust-gas flow in the flow section, wherein the actuator is in fluid communication with the gas volume in the flow section, as a result of which the flow direction of the exhaust gas which flows through the flow section is influenced.

A component which is provided for the exhaust-gas aftertreatment may be a catalytic converter which is formed from a metallic honeycomb body and through which the exhaust gas may flow. A heating element may also be provided which is heated electrically and thus heats the exhaust gas flowing around the heating element.

The flow section is formed, for example, by a housing in which the components for the exhaust-gas aftertreatment are accommodated.

The actuator is an active element which, depending on the actual design, may influence the gas flow within the flow section using various operating principles. For example, the actuator may have an influence by influencing the pressure conditions or by opening and closing flaps. For this purpose, the actuator is in fluid communication with the gas volume located in the flow section, therefore, the action of the actuator has a direct effect on the gas volume located in the flow section.

It is advantageous if the component which is provided for the exhaust-gas aftertreatment in the flow section is formed by a heating device and/or by a catalytic converter and/or by an evaporation device.

A heating device for heating the exhaust gas flowing through the flow section is advantageous in order to more rapidly heat up the catalytic converters and thus to enable more rapid conversion of the pollutants located in the exhaust gas at the corresponding catalytic converters. A heating device is advantageous in the case of exhaust-gas sources with a generally low exhaust-gas temperature. For example, small diesel engines with medium to small cubic capacity have low exhaust-gas temperatures. In principle, however, the trend towards low exhaust-gas temperatures is also present in gasoline engines and internal combustion engines in general.

A heating device for exhaust-gas systems of hybrid vehicles, which also allow locomotion when the internal combustion engine is switched off, is likewise advantageous. The exhaust-gas system may be cooled here by switching off the internal combustion engine in phases, which may result that the minimum temperature required for the exhaust-gas conversion is no longer reached. By switching on a heating device, on the one hand the exhaust-gas system per se is preheated and on the other hand the exhaust gas flowing after the engine is started is heated up more rapidly such that the operating temperature, also referred to as the light-off temperature of the catalytic converter, is reached as rapidly as possible.

It is also advantageous if the actuator is formed by a pump. A pump is advantageous because a volume of gas may thereby be conveyed in a simple manner. Advantageously, a pump that is already installed in a motor vehicle, such as, for example, an active purge pump, as is used, for example, for flushing the collecting container for air containing hydrocarbons, is used.

A preferred exemplary embodiment is characterized in that the exhaust-gas system has a bypass which leads from a point downstream of the component which is provided for the exhaust-gas treatment to a point upstream of the component, wherein the exhaust gas located in the flow section is at least partially conveyed along the bypass by the actuator. The effect which is achieved by diverting the exhaust gas at a point downstream of the components for the exhaust-gas aftertreatment, such as the heating device, and supplying the exhaust gas again at a point upstream of the components is that the exhaust gas flows through the components at least twice. This results in more efficient heating up, since the dwell time of the exhaust gas at the heating device is increased. The exhaust-gas conversion at the catalytic converters is also improved as a result.

It is also preferable if the bypass is closed or is opened by closure elements. It is advantageous if the closure elements are formed by flap elements which may largely or even completely close the cross section of the flow section. This makes it possible to partition off a gas volume between the two closure elements. This is then conveyed through the bypass, for example by a pump, and may thus flow through the catalytic converters and the heating element again. An unintentional drop in temperature at the catalytic converters is thereby delayed.

In addition, it is advantageous if two actuators are arranged at the flow section, a first actuator being arranged downstream of the component which is provided for the exhaust-gas aftertreatment and a second actuator being provided upstream of the component. By providing two actuators, the influence on the gas volume is increased. The two actuators advantageously interact in such a way that the movement of the exhaust gas counter to the direction of flow is improved. For example, one actuator could generate a positive pressure while the other actuator generates a negative pressure. The generation of phase-shifted pressure waves could also be advantageously implemented.

Furthermore, it is advantageous if the actuators generate a pulsation of the gas volume located in the flow section, the pulsation of the gas volume enabling the flow direction of the gas volume to be reversed.

To generate a pulsation, pressure waves are generated, for example, which slow down the flow velocity of the exhaust gas or even temporarily reverse the flow direction.

Furthermore, a pulsation of the gas volume may also be generated by a specific activation of a pump arranged in a bypass.

It is also expedient if the actuator is formed by an expandable or compressible volume, wherein a portion of the gas in the flow section is sucked into the actuator volume by expansion of the actuator volume and, when the actuator volume is compressed, the gas in the actuator volume is pressed into the flow section.

In a manner similar to a bellows, it could thus be possible for exhaust gas to be specifically sucked up and released again. The quantity of the exhaust gas moved in each case is controlled by the actuator volume. As a result of the sucking up by the actuator, the exhaust gas is in practice guided again past the catalytic converters and/or the heating device, as a result of which the heating of the exhaust gas and/or the conversion rate at the catalytic converter is likewise improved.

In addition, it is advantageous if the actuator is arranged upstream of the component which is provided for the exhaust-gas aftertreatment.

Furthermore, it is expedient if at least one closing device is provided in the flow section, by which the flow section is closed.

The flow section is closed at least temporarily by a closing device, for example a rotatably mounted flap. This is advantageous because the exhaust gas which is located in the flow section is thereby prevented from flowing out of the flow section. This makes influencing the flow easier, since there is additionally also no need to work against the natural outflow of the exhaust gas. The exhaust gas to be moved by the actuators may also be limited in terms of quantity.

Advantageous developments of the present invention are described in the following description of the Figures.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

In the following, the invention is explained in detail using exemplary embodiments with reference to the drawings. In the drawings:

FIGS. 1 to 4 each show a sectional view through a flow section with two catalytic converters arranged therein and a heating element arranged between the catalytic converters, the exemplary embodiments of the Figures differing in each case by the type and arrangement of the actuators via which the gas movement in the flow section is influenced.

### DETAILED DESCRIPTION OF THE PREFERRED EMBODIMENTS

The following description of the preferred embodiment(s) is merely exemplary in nature and is in no way intended to limit the invention, its application, or uses.

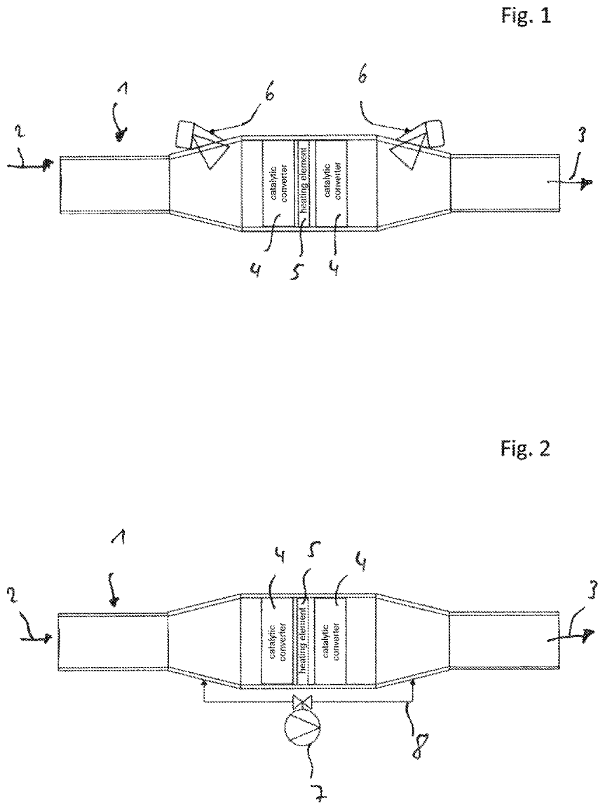

FIG. 1 shows a sectional view through a flow section 1 through which an exhaust gas from an exhaust-gas source may flow along the direction 2. After flowing through the flow section 1, the exhaust gas flows out of the flow section 1 along the direction 3.

Two catalytic converters 4 and a heating device 5, through which the flow may pass successively, are arranged within the flow section 1.

This design is identical in FIGS. 2 to 4 below, and therefore it is not described further in the Figures and the same reference signs are also used for identical parts.

Two actuators 6 are arranged on the housing forming the flow section 1. The actuators 6 serve to influence the exhaust-gas flow in the interior of the flow section 1.

In the example of FIG. 1, the actuators 6 are identical, but oriented in opposite directions to one another. One of the actuators 6 is arranged downstream of the catalytic converters 4, the other actuator 6 is arranged upstream of the catalytic converters 4.

The actuators 6 in the exemplary embodiment of FIG. 1 generate a pulsation of the gas located in the flow section 1, for example by pressure waves. The actuators 6, which are oriented in an opposed manner to one another, may for this purpose, for example, introduce phase-shifted pressure waves into the flow section 1 in order to generate a movement of the exhaust gas counter to the actual flow direction.

FIG. 2 shows an actuator 7 which is formed by a pump. The actuator 7 transports exhaust gases via a bypass 8, which branches off downstream of the catalytic converters 4 from the flow section 1 and opens upstream of the catalytic converters 4 into the flow section 1. By adding the exhaust gas again upstream of the catalytic converters 4 and the heating device 5, the exhaust gas may flow through them again and thus, on the one hand, is heated up further and, on the other hand, the pollutants contained in the exhaust gas are further converted, if a complete conversion has not yet been achieved during the first pass through.

Closure elements, for example in the form of rotatably mounted flaps, are also provided in the flow section 1 upstream and downstream of the bypass 8 in the flow direction. By closing the flow section 1 using the two closure elements, the gas volume located in the cavity formed between the closure elements is conveyed in a circuit through the catalytic converters 4 and the heating element 5 by the actuator 7, which is formed for example by a pump. The gas volume is pumped here into the bypass 8 in each case downstream of the last catalytic converter 4 in the flow direction and pumped back into the main flow section upstream of the first catalytic converter 4 in the flow direction.

By circulating the gas volume, the temperature at the catalytic converters 4 is kept high for longer. This is advantageous, for example, when the internal combustion engine is not running, since the absence of new exhaust gas flowing in would otherwise result in a significant reduction in the temperature at the catalytic converters 4. With active use of the heating element 5, the cooling of the catalytic converters is accordingly delayed even further.

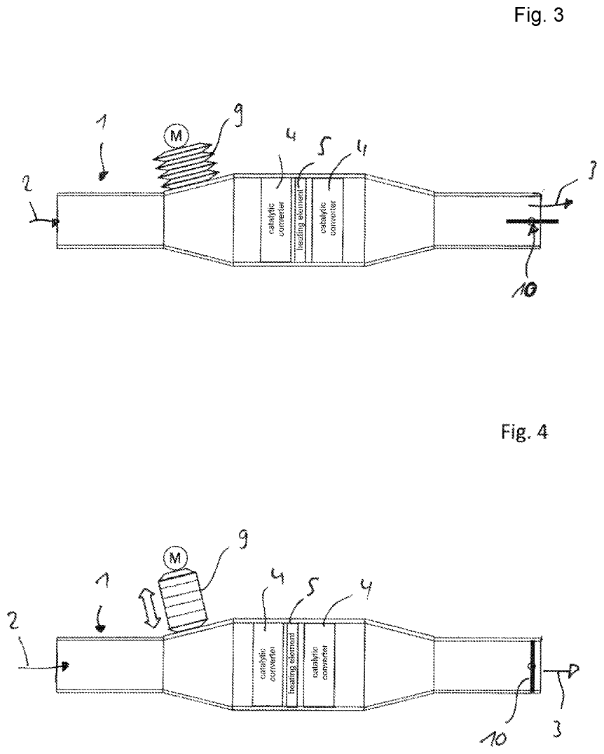

FIG. 3 and FIG. 4 show an actuator 9 at the flow section in two different operating states. The actuator 9 is formed by a compressible volume which is compressed in a similar way to a bellows. In FIG. 3, the actuator 9 is shown in the compressed state, while the actuator 9 in FIG. 4 is shown non-compressed in the initial state.

The compression and the subsequent expansion work in a similar way to a bellows. In this way, some of the exhaust gas in the flow section 1 is sucked up and expelled again. A pulsation of the exhaust gas is thereby generated within the flow section 1, as a result of which the exhaust gas is at least partially guided past the catalytic converters 4 and the heating device 5 several times.

FIGS. 3 and 4 each also show the flap 10, which is rotatably mounted in the flow section 1, at the end of the flow section 1. The cross section of the flow section 1 is closed or opened up by the flap 10. As a result, the gas volume within the flow section 1 is limited. The outflow from the flow section 1 is also at least temporarily interrupted, which is why it is easier to generate a reverse movement of the exhaust gas.

The exemplary embodiments of FIGS. 1 to 4 are not of a restrictive nature and serve to illustrate the concept of the invention.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An exhaust-gas system for guiding and aftertreating exhaust gases from an exhaust-gas source, such as an internal combustion engine, comprising:
a flow section through which exhaust gas may flow;
at least one component which is provided for the exhaust-gas aftertreatment, the at least one component arranged in the flow section and through which the exhaust gas may flow; and
at least one actuator for influencing the exhaust-gas flow in the flow section;
wherein the actuator is in fluid communication with the gas volume in the flow section, as a result of which the flow direction of the exhaust gas which may flow through the flow section is influenced.

2. The exhaust-gas system of claim 1, the at least one component further comprising at least one of a heating device, a catalytic converter, or an evaporation device.

3. The exhaust-gas system of claim 1, the at least one actuator further comprising a pump.

4. The exhaust-gas system of claim 3, the exhaust-gas system further comprising:
a bypass which leads from a point downstream of the at least one component to a point upstream of the at least one component;
wherein the exhaust gas located in the flow section is at least partially conveyed along the bypass by the at least one actuator.

5. The exhaust-gas system of claim 4, wherein the bypass is closed or is opened up by at least one flap.

6. The exhaust-gas system of claim 1, wherein the at least one actuator arranged at the flow section.

7. The exhaust-gas system of claim 6, the at least one actuator further comprising a first actuator and a second actuator, wherein the first actuator is arranged downstream of the at least one component and the second actuator is provided upstream of the at least one component.

8. The exhaust-gas system of claim 7, wherein the first actuator and the second actuator generate a pulsation of the gas volume located in the flow section, the pulsation of the gas volume enabling the flow direction of the gas volume to be reversed.

9. The exhaust-gas system of claim 6, the at least one actuator further comprising an expandable or compressible actuator volume, wherein a portion of the gas in the flow section is sucked into the actuator volume by expansion of the actuator volume and, when the actuator volume is compressed, the gas in the actuator volume is pressed into the flow section.

10. The exhaust-gas system of claim 9, wherein the at least one actuator is arranged upstream of the at least one component which is provided for the exhaust-gas aftertreatment.

11. The exhaust-gas system of claim 1, further comprising at least one closing device is provided in the flow section, wherein the flow section is opened or closed by the at least one closing device.
